(19) United States
(12) Patent Application Publication
(10) Pub. No.: US 2008/0100875 A1
(43) Pub. Date: May 1, 2008

(54) COMMUNICATION DEVICE AND IMAGE PROCESSING DEVICE

(75) Inventors: Hideya TAKENOSHITA, Osaka (JP); Hiroyuki Tsuji, Kyoto (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 11/923,336

(22) Filed: Oct. 24, 2007

(30) Foreign Application Priority Data
Oct. 27, 2006 (JP) JP 2006-293203

(51) Int. Cl. H04N 1/00

(52) U.S. Cl. 358/403; 358/400

(57) ABSTRACT

A communication device in accordance with the present invention includes a transmitting unit capable of transmitting a file to an external device, a storage unit for storing a string and an address of the external device so that the character string and the address of the external device are associated with each other, and a file name setting unit for setting a default file name of the file so that the default name includes the string stored in the character storage unit so as to be associated with the address to which the file is transmitted.

### CROSS-REFERENCE TO RELATED APPLICATIONS

This application claims priority to Japanese Patent Application No. 2006-293203, and the entirety of which is hereby incorporated by reference in its entirety.

### BACKGROUND OF THE INVENTION

### Field of the Invention

The present invention relates to a communication device capable of externally transmitting data and an image processing device provided with the same.

Improvements have been made in communication terminals that are allowed to transfer files (e.g., image files) so that users can easily specify a recipient to which a file is transferred.

For example, Japan Patent Application Publication JP-A-2005-84981 discloses a plurality of communication terminals and a web server, all of which are connected to a network. The communication terminals have file transferring functions performed by means of the server message block (SMB), the file transfer protocol (FTP), and the like. On the other hand, the web server holds a browser list and a recipient list (browsing list) in which information such as an address of the respective communication terminals is included.

The publication JP-A-2005-84981 describes the following operation flow diagram as a browsing operation that is performed when a communication terminal transfers a file to another communication terminal. First, a communication terminal accesses the web server and requests a browser list. When the communication terminal receives a response from the web server and obtains the browser list, it selects a browser for requesting a “browsing list” from the browser list, and requests the browsing list based on the name of the selected browser. The above described steps are repeatedly performed until the requested browsing list is obtained.

When the browsing list is obtained by performing the above described steps, in other words, when a shared folder list is obtained and then a user selects a recipient from the shared folder list, the communication terminal from which a file is transmitted (i.e., source terminal) transfers a file to a communication terminal to which the file is transmitted (i.e., recipient terminal) based on the selection.

The publication JP-A-2005-84981 describes that the above described steps allows a file transfer to be performed without a user's input of a recipient.

### SUMMARY OF THE INVENTION

In the invention described in the publication, users are required to select and to specify a recipient to which a file is transmitted from a recipient list, and is further required to input a name of the file. Accordingly, the invention is not necessarily convenient enough for users.

In view of the aforementioned hitherto known problem, it is an object of the present invention to provide an image processing device that is capable of reducing a user's burden in performing data transmission.

A communication device in accordance with the present invention includes a transmitting unit capable of transmitting a file to an external device, a storage unit for storing a character string and an address of the external device so that the character string and the address of the external device are associated with each other, and a file name setting unit setting a default name of the file to include the character string stored in the storage unit as part of the default name to associate the default name with the address to which the file is transmitted. Note that an image processing device that includes this communication device and a method for setting a file name are also included within the technical scope of the present invention.

### BRIEF DESCRIPTION OF THE DRAWINGS

FIG. 1 is a block diagram illustrating a main configuration of a multifunction peripheral (MFP) or a multifunction device according to an embodiment of the present invention.

FIG. 2 is a plan view illustrating a main configuration of an operation and display unit according to an embodiment of the present invention.

FIG. 3 is a flowchart illustrating a series of steps of a character string registration operation performed by the MFP.

FIG. 4 is a screen shot of a character string input screen displayed when the character string registration operation is performed by MFP.

FIG. 5 is a flowchart illustrating a series of an image transmission operation performed by the MFP.

FIG. 6 is a screen shot of a recipient input screen displayed when the image transmission operation is performed by the MFP.

FIG. 7 is a screen shot of a file name input screen.

FIG. 8 is a screen shot of a confirmation screen through which a user is allowed to confirm a recipient.

FIG. 9 is a screen shot of an address book screen on which an address list is displayed.

FIG. 10 is a screen shot of a registered character string screen on which a registered character string list is displayed.

FIG. 11 is a screen shot of a file name input screen when a plurality of character strings is set to be associated with an address.

### DETAILED DESCRIPTION OF THE PREFERRED EMBODIMENTS

An embodiment of a communication device in accordance with the present invention will be hereinafter described in detail with reference to the attached figures. Note that in the following embodiment, a communication device in accordance with the present invention is applied to an image processing device, but it is not limited to be applied to this. It is also possible to use the communication device as a device for transmitting data such as documents and sounds excluding images.

Also, a so-called multifunction peripheral (MFP) with functions of a printer, a copier, and a facsimile machine is exemplified as an image processing device in the following embodiment. However, the present invention is not limited to this configuration. In other words, it is possible to change suitably a specific configuration of the MFP in accordance with the present embodiment so long as the MFP has a function of transmitting an image.

### 1. Configuration of MFP

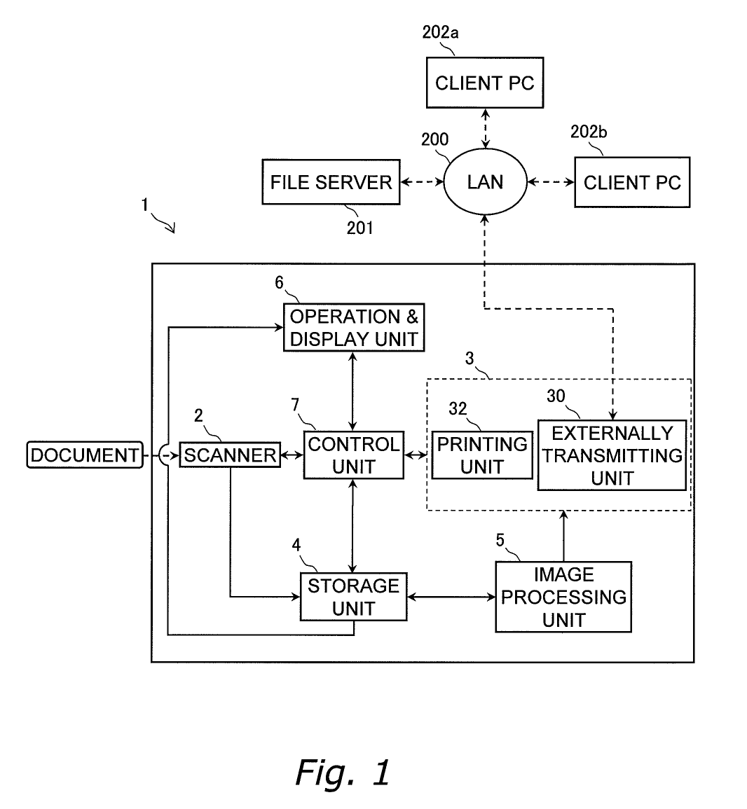

FIG. 1 is a block diagram illustrating a main configuration of a multifunction peripheral (MFP) 1 according to an embodiment of the present invention. The MFP 1 includes a scanner 2, an output unit 3, a storage unit 4, an image processing unit 5, an operation and display unit 6, and a control unit 7. In addition, the output unit 3 includes an externally transmitting unit 30, a printing unit 32, and the like. Among these units, the externally transmitting unit 30, the storage unit 4, and the control unit 7 function as a communication device.

The scanner 2 includes an image sensor such as a charge-coupled device (CCD), an analog-digital converter (A/D converter) for digitalizing an analog signal that is outputted from the image sensor, and the like. The scanner 2 is capable of scanning an image on a document and obtaining the image data.

The externally transmitting unit 30 is capable of transmitting data to a file server 201, client personal computers (client PCs) 202a and 202b, or the like through a local area network (LAN) 200. The externally transmitting unit 30 is capable of sharing/transferring a single or plurality of files with/to the file server 201 and the client PCs 202a and 202b by means of protocols such as the file transfer protocol (FTP) and the symmetric multiprocessing (SMP). In addition, the externally transmitting unit 30 is capable of sending an e-mail, a facsimile, and the like. The externally transmitting unit 30 includes a modem (modulator/demodulator), a terminal adapter (TA), and the like, all of which are not shown in the figure. It is capable of performing communication with a single or plurality of external machines through a communication link such as a telephone line, an integrated services digital network (ISDN) line, a wireless communication, a leased line or a cable television service (CATV) line, or through a network such as a local area network (LAN), a wide area network (WAN), and the Internet. It is also capable of sending and receiving a facsimile in conformity with a regulation such as the Group 3 (G3) and the Group 4 (G4).

The printing unit 32 is capable of printing out image data on a sheet of paper.

The storage unit 4 has an address book function for storing an address and a name of the address so that they are associated with each other. In the present specification, the term “address” means information by which a recipient is allowed to be specified. For example, the “address” includes a facsimile/telephone number, a folder's location (e.g., URL), an e-mail address, and a printer name and its installation site. In addition, the term “name of an address” (or simply “address name”) corresponds to a character string (hereinafter called “string”) to be stored as data indicating an address. Note that a name of a person or a company who is a user of an e-mail address or a facsimile number, or a name of a MFP to which data are transmitted, is often used as the “name of an address.”

The storage unit 4 is capable of functioning as a string storage unit for storing a string and an address so that they are associated with each other. Note that “storing a string and an address so that they are associated with each other” includes storing a string and an address name so that these are associated with each other. As described above, an address and a name of the address are stored in the storage unit 4 so that they are associated with each other. Accordingly, when the string and the address name are stored to be associated with each other, this makes it possible to obtain a similar working effect as storing the string and the address to be associated with each other. Details of the string will be hereinafter described. Note that a string stored in the storage unit 4 may be hereinafter called “registered string.”

Also, the storage unit 4 is capable of functioning as a file storage unit that stores a file transmitted from an eternal device, and/or as a file storage unit that receives image data obtained through a document scanning by the scanner 2 and then storing the image data as a file by performing a predetermined processing. Note that a variety of storage devices such as a hard disk drive (HDD) may be used as the storage unit 4 if needed.

The image processing unit 5 converts the image data outputted from the storage 4 into image data to be transmitted (hereinafter called “transmission image data”), and transmits the converted data to the output unit 3.

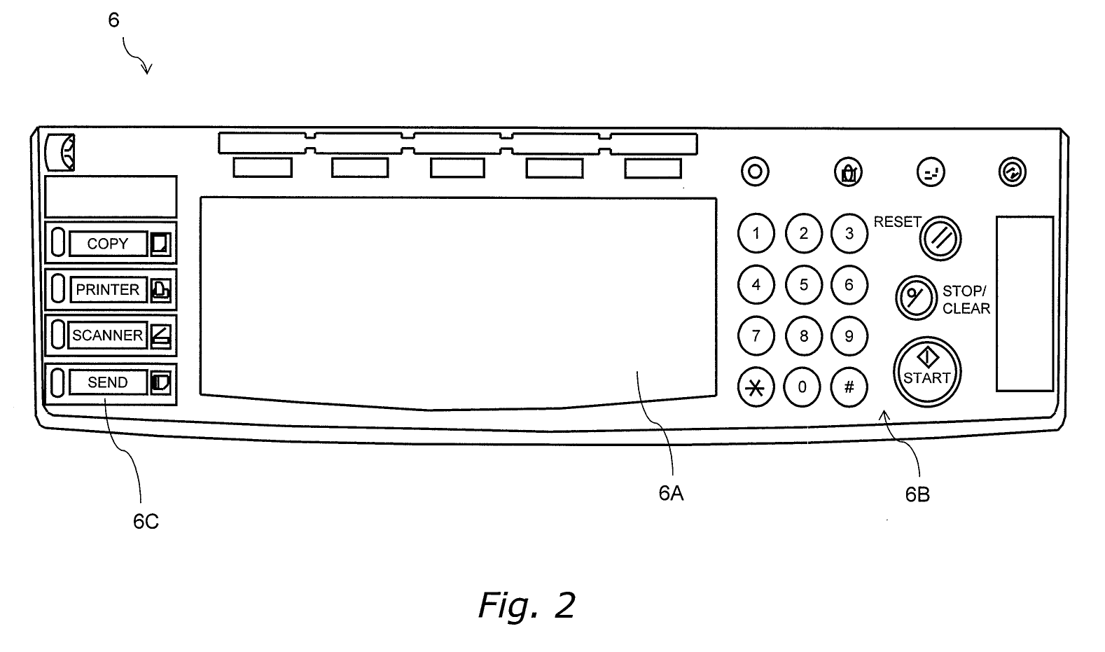

The operation and display unit 6 includes a display unit 6A such as a liquid crystal display (LCD), and a group of physical keys 6B including ten keys, a start key, a stop key and a cancel key. It provides a user with a variety of information, and also receives a user's input (see FIG. 2). The group of physical keys 6B also includes a transmission function key 6C functioning as a function selection key.

The control unit 7 sends/receives a data signal and a control signal to/from each of the units included in the MFP 1 in accordance with a request/instruction received from the outside through the operation and display unit 6 or the LAN 200, and thus comprehensively controls operations such as the image processing operation and the data transmission operation. Specifically, it is possible to make up the control unit 7 using a central processing unit (CPU), a read only memory (ROM), a random access memory (RAM), and the like. The CPU is capable of running programs by performing a variety of computations. The ROM stores control programs to be executed by the CPU, operational programs for the units in the MFP 1, and the like. On the other hand, the RAM functions as a work area of the CPU, and also includes areas such as an area for storing contents of a user's input.

Especially, the control unit 7 functions as a variety of units such as a file creation unit, a file name setting unit, and a file name changing unit.

Specifically, as the file creation unit, the control unit 7 is capable of creating a file such as an image file based on the data such as the image data obtained by the scanner 2.

In addition, as the file name setting unit, the control unit 7 is capable of setting a name of a file to be externally transmitted by means of a default file name setting. The control unit 7 is capable of setting a name of a file so long as the file is to be transmitted to a recipient, regardless of whether the file is a newly created file or a file that has been stored in the storage unit 4 and its file name has already been set. When an address of a recipient to which a file is transmitted is specified by a user and the specified address corresponds to an address that has been stored in the storage unit 4, the control unit 7 is capable of setting a registered string corresponding to this address to be the name of the file to be transmitted.

Also, as the file name changing unit, the control unit 7 is capable of changing a file name that “the file name setting unit” has set by means of the default file name setting. Especially, when the operation and display unit 6 functions as a change reception unit and receives a user's request of changing a file name, the control unit 7 is capable of changing the file name from the default file name based on the content of the request. Thus, the control unit 7 is also configured to be a file name change unit.

Note that a “file name” is preferably a portion of a name assigned to a file, which does not include a filename extension (e.g., “pdf,” “gif,” “tif,” and “jpg”) Especially, the term “file name” hereinafter means a portion of a name assigned to a file, which includes a single or plurality of characters from an initial to a character immediately before a dot/period, i.e., “.”, in other words, a portion of a name excluding a filename extension and a dot/period immediately before the filename extension.

The control unit 7 is also capable of instructing the storage unit 4 or the output unit 3 to store the file to which a file name is set as described above, and to output the file in the form of printing or data transmission.

A certain trend is often observed in file names depending on recipients. Accordingly, there is a higher possibility that a default file name corresponds to a user's intended file name when a string stored to correspond to a recipient is set to be a default file name, compared when a randomly created string is set to a default file name.

A “string,” which is stored to be associated with an address, may be set by a user as desired, and is not limited to a specific type of string. In other words, the character type included in a “string” and the length of a “string” are not particularly limited. Here, the character includes the symbol. For example, a sequence of 2-10 or 3-5 consecutive characters may be set as a “string.” Note that the “character” includes the alphabet and/or other type of characters, the number, the symbol, and the like.

In addition, “including a string” means that it is possible to set a string including the registered string and other types of characters to be a default file name. In other words, when a file is transmitted to a recipient, the control unit 7 is capable of setting a string, which is created by adding a number, a time, a client/sender of data transmission, and/or a source of data transmission and the like to the registered string that is stored to be associated with the recipient, to be a default file name. Also, the control unit 7 may set a default file name by adding an additional string to a string that has been created by adding the number or the like to the registered string.

Here, the “number” may be defined as the transmission order of the file among all the files to be transmitted to the recipient, or as the transmission order of the file among all the files to be transmitted from the MFP 1. Also, the “time” may be a time when the file is transmitted, a time when the file is created, or the like. Also, the above described “number” may be determined based on all the past file transmission histories, or the transmission histories of the present day when the file is transmitted. Note that the transmission histories are stored in the storage unit 4. For example, when a registered string “abcd” is associated with a recipient specified by a user, the control unit 7 may set the file name as “abcd.” Also, when the present file transmission to the specified recipient is the tenth transmission to the recipient, the control unit 7 may set the file name as “10abnd,” “abcd-10,” “10-abcd,” or the like.

The “time” includes year, month, day, hour, minute, second, and the like. For example, when a file transmission is performed on May 11, 2006, the control unit 7 may set the file name as “060511abcd.”

The “client of a data transmission” may be any string so long as it indicates a user that requested a file transmission. In addition, the “client of a data transmission” includes a user name, a user ID, an initial of a user, and the like, which has been stored in the storage unit 4.

The “source of a data transmission” is a string indicating a device from which data are transmitted. For example, it includes a string indicating an address or a name of the MFP 1, and the like.

Also, a single address and a single string do not necessarily correspond to each other. In other words, a plurality of addresses and a single string are stored in the storage unit 4 so as to be associated with each other, or a plurality of strings and a single address are stored in the storage unit 4 so as to be associated with each other.

Also, in the present embodiment, the “recipient” is not limited to a recipient to which data are normally transmitted (hereinafter called “to:” recipient), and may be a recipient to which data are transmitted by means of the carbon copy transmission (hereinafter called “cc:” recipient).

### 2. Character String Registration Operation

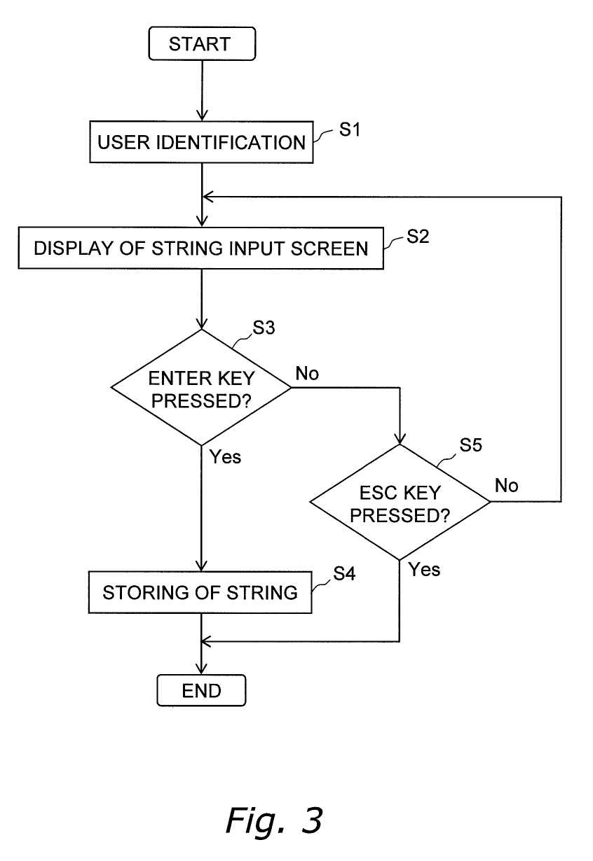

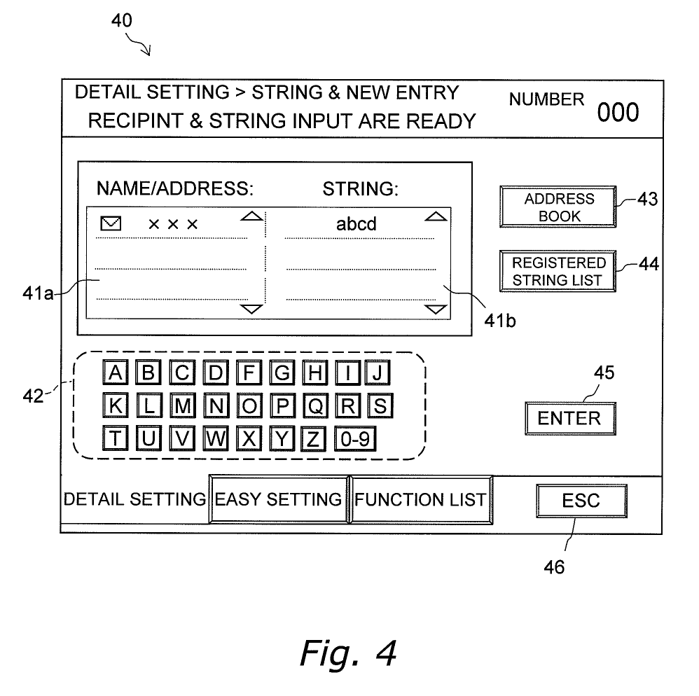

With reference to FIGS. 3 and 4, an example of a character string registration operation will be hereinafter explained in detail. The operation includes a plurality of steps, and it is performed when the MFP 1 receives a user's input of a string. Here, it is assumed that each user is allowed to set a string and an address corresponding to the string. FIG. 3 is a flow chart illustrating the steps of the operation, and FIG. 4 is a screen shot of a character string input screen displayed on a display unit 6A during the operation.

When a user inputs a new entry of a string corresponding to an address through a screen displayed on the display unit 6A, a series of steps are started as follows.

First, the control unit 7 identifies a user (Step S1). Specifically, a user confirmation screen (not shown in the figure) is displayed on the display unit 6A under the control of the control unit 7. The user confirmation screen is a screen through which user's input of a user name and a password are received. Based on these input contents, the control unit 7 is capable of identifying a user (i.e., client/sender of data transmission). In addition, the information is also used for an authentication process between a file server and a client PC.

As illustrated in FIG. 4, a character string input screen 40 is displayed on the display unit 6A under the control of the control unit 7 (Step S2 of FIG. 3). Here, an address input field 41a, a string input field 41b, character input keys 42, an address book key 43, a registered string list display key 44, an enter (ENTER) key 45, an escape (ESC) key 46, and the like are displayed on the string input screen 40.

The address input field 41a and the character string input field 41b remains blank until a user's input is received.

A user is allowed to input directly an address and a string by pressing the character input keys 42.

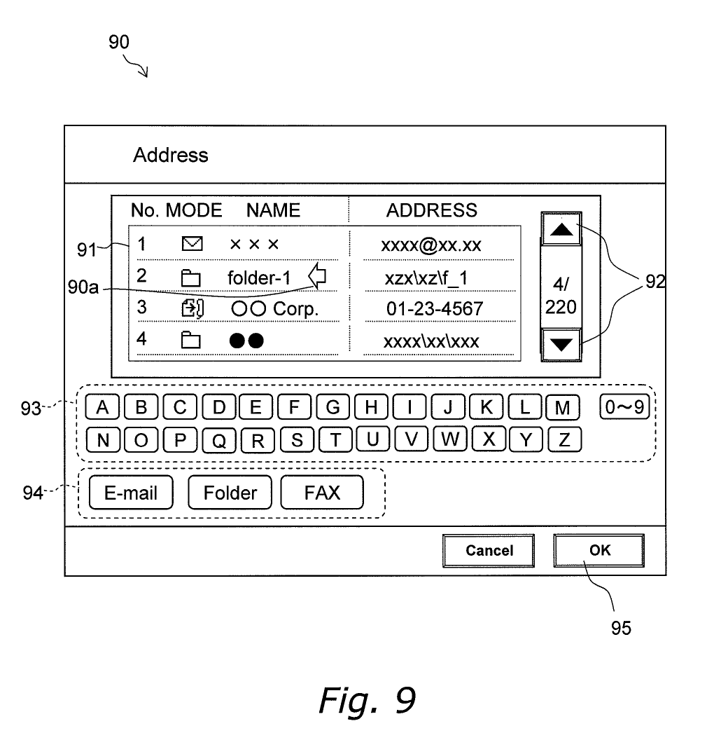

In addition, when the address book key 43 is pressed, an address list stored in the storage unit 4 is displayed on the display unit 6A under the control of the control unit 7. Thus, a user is allowed to select an address or a name that is included in the address list. When the address or the name is selected in this way, it is displayed in the address input field 41a. With reference to FIG. 9, displaying an address list will be hereinafter explained in detail.

FIG. 9 illustrates an address book screen 90 as an example of a display screen of an address list. The address book screen 90 includes an address data display field 91, page keys 92, a group of index keys 93, mode keys 94, an OK key 95, and the like. An address list of recipients that has been stored in the storage unit 4 is displayed in the address data display field 91. When any specific instruction is not given by a user, different types of addresses, such as an e-mail address to which an e-mail is transmitted, a folder name to which a file is transmitted, a facsimile/telephone number to which a facsimile is transmitted, and the like, are simultaneously displayed in the address data display field 91. Here, the order of the addresses displayed in the address data display field 91 is not limited to a particular order. However, in the present embodiment, the addresses are configured to be displayed in the address data display field 91 in the order of the memory number that is assigned to each address.

In the address book screen illustrated in FIG. 9, when either of the page keys 92 is pressed, a page displayed in the address data display field 91 is turned back or forth under the control of the control unit 7. In other words, when either of the page keys 92 is pressed, the screen image being displayed in the address data display field 91 is changed so that addresses with larger/smaller memory numbers than the memory numbers assigned to the addresses being displayed in the field 91 are allowed to be displayed in the field 91.

In addition, the group of index keys 93 includes keys corresponding to the alphabet, A to Z, and numerals 0 to 9. When a key corresponding to a letter is pressed, a single or plurality of recipients is displayed in the address data display field 91 under the control of the control unit 7. In this case, the recipient(s) displayed in the field 91 has a name, an e-mail address, a folder name or the like, the initial of which corresponds to the pressed letter. On the other hand, when a key corresponding to a numeral is pressed, a single or plurality of recipients is displayed in the field 91. In this case, however, the recipient(s) displayed in the field 91 has a name, an e-mail address, a folder name or the like, the initial of which corresponds to the pressed numeral.

The mode keys 94 include an “E-mail” key, a “Folder” key, and a “FAX” key. When any of the mode keys 94 is pressed, the screen image being displayed in the address data display field 91 is changed so that only the address data (e.g., an e-mail address, a folder name, or a facsimile/telephone number) corresponding to a mode assigned to the pressed mode key 94 is allowed to be displayed under the control of the control unit 7.

A cursor/pointer 90a is also displayed on the address book screen 90. The cursor 90a is configured to be moved depending on a user's touch location on the address data display field 91, which is detected by a touch sensor (not shown in the figure). When the OK key 95 is pressed, the control unit 7 sets an address that is being pointed by the cursor 90a when the OK key 95 is pressed to be an address that is stored so as to be associated with a string.

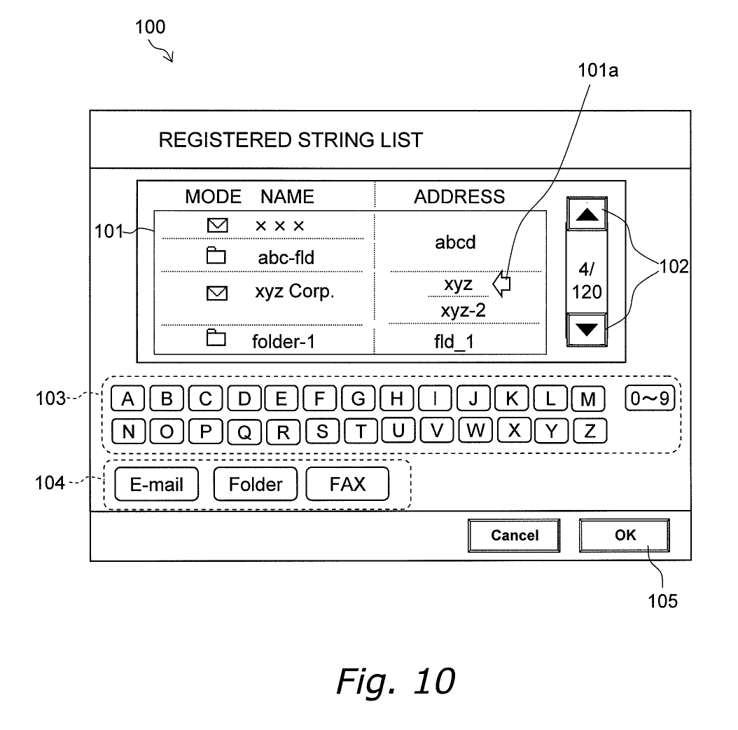

Again, with reference to FIG. 4, when the registered string list display key 44 is pressed, a string that has been already registered is allowed to be displayed on the display unit 6A under the control of the control unit 7. In other words, the display unit 6A functions as a list presentation unit that presents a list of the registered strings to a user. FIG. 10 illustrates an example of a registered string list that is displayed on the display unit 6A.

As illustrated in FIG. 10, a registered string screen 100 is substantially the same as the address book screen 90 except that the screen 100 includes a registered content display field 101 in which an address (and/or a name) and a registered string stored in the storage unit 4 so as to be associated with the address are simultaneously displayed side by side. The registered string screen 100 includes a cursor 101a, page keys 102, a group of index keys 103, mode keys 104, an OK key 105, and the like as well as the registered content display field 101.

The cursor 101a is allowed to point either of a registered string or an address (or a name), both of which are displayed on the registered string screen 100. The page keys 102, the group of index keys 103, and the mode keys 104, respectively, have the similar functions to those of the page keys 92, the group of index keys 93, and the mode keys 94, all of which are displayed in the address book screen 90.

If the cursor 101a points a registered string when the OK key 105 is pressed, the registered string being pointed by the cursor 101a is inputted as a string that is newly stored so as to be associated with an address. In addition, if the cursor 101a points to an address (or a name) when the OK key 105 is pressed, the address or name to which the cursor 101a points is inputted as an address or name that is stored so as to be associated with the string.

As illustrated in FIG. 4, the address and string that are inputted in this way are displayed in the address input field 41a and the character string input field 41b, respectively. As described above, a single recipient and a single string do not have to correspond to each other. Therefore, a plurality of recipients and a plurality of strings are allowed to be inputted, respectively.

Again, with reference to FIG. 3, when the enter key 45 is pressed while a recipient and a string are inputted (Yes in Step S3), the recipient and the string are stored in the storage unit 4 (Step S4), and the string registration operation is completed (End in the flow chart of FIG. 3). On the other hand, if the enter key 45 is not pressed (No in Step S3) but the escape key 46 is pressed (Yes in Step S5), a string is not stored in the storage unit 4 and the string registration operation is terminated (End in the flow chart of FIG. 3).

### 3. Image Transmission Operation

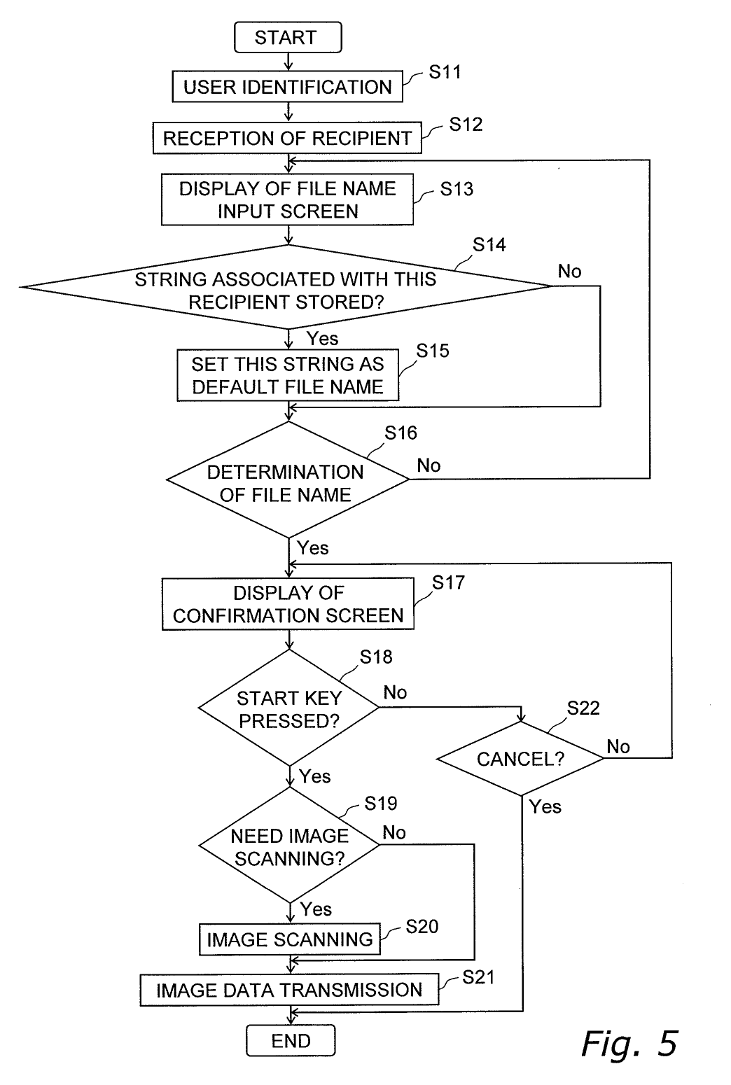

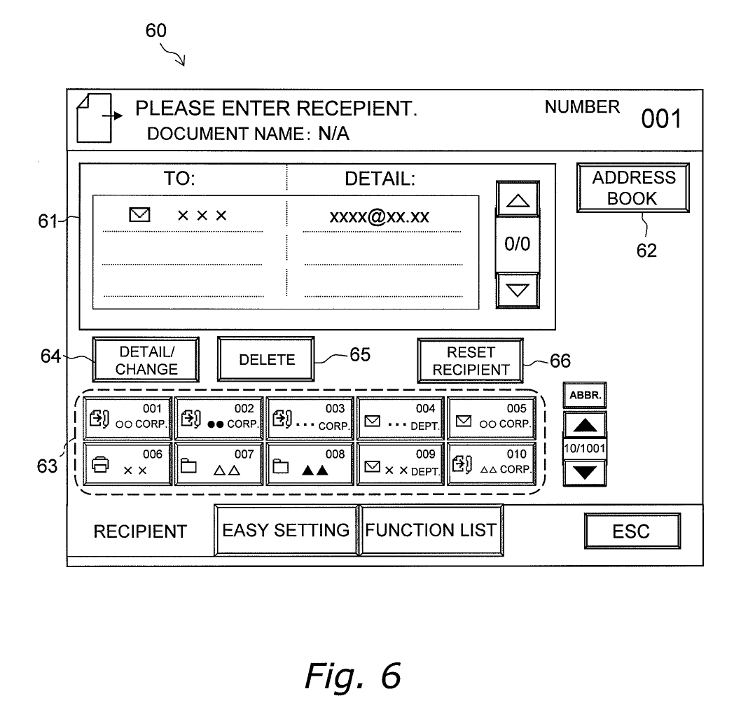

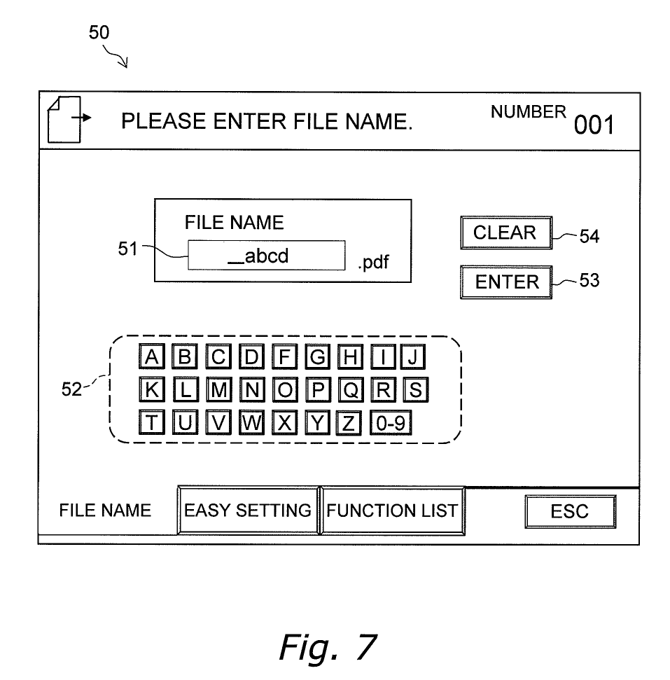

With reference to FIGS. 5 to 7, an example of an image transmission operation performed by the MFP 1 will be hereinafter described in detail. In this example, the control unit 7 is configured to set a default file name as a registered string itself. FIG. 5 is a flow chart illustrating a series of steps of the image transmission operation, and FIGS. 6 and 7 are screen shots displayed on the display unit 6A during the image transmission operation.

When the transmission function key 6C illustrated in FIG. 2 is pressed, a series of steps are started as follows. First, as illustrated in FIG. 5, the control unit 7 identifies a user (Step S1). This step is the same as the above described step S1 illustrated in FIG. 3. Next, the control unit 7 receives a recipient to which a file is transmitted (Step S12). Specifically, a screen for receiving a recipient is firstly displayed on the display unit 6A.

FIG. 6 illustrates a recipient input screen 60 as an example of the screen for receiving a recipient. A recipient display field 61 for displaying a single or plurality of recipients, an address book key 62, a group of abbreviated keys 63, a detail/change key 64, a delete key 65, a recipient reset key 66, and the like are displayed on the recipient input screen 60.

The recipient display field 61 remains blank until a user inputs a recipient. When a request for specifying a recipient is inputted through the recipient input screen 60 while the recipient display field 61 remains blank, a recipient is displayed in the field 61 (see FIG. 6). Input of a recipient is performed as follows.

When a user presses the address book key 62, a recipient list preliminarily stored in the storage unit 4 is displayed on the display unit 6A. Display of the address list has already been explained with reference to FIG. 9, and accordingly its detail explanation will be hereinafter omitted. Note that in specifying a recipient through the address book screen 90, the control unit 7 sets an address being pointed by the cursor 90a when the OK key 95 is pressed to be a recipient.

In addition, note that a single or plurality of recipients may be preliminarily stored in the storage unit 4 as abbreviated recipients. The recipient(s) stored in the storage unit 4 as the abbreviated recipients is/are displayed as the group of abbreviated keys 63 on the screen. A user is also allowed to input a recipient by pressing the group of abbreviated keys 63. In addition, a user is allowed to input directly recipient information by pressing character input keys (not shown in the figure).

When the detail/change key 64 is pressed, the operation and display unit 6 is allowed to display details of recipients that have been once inputted and is also allowed to receive a request of changing the recipients. When the delete key 65 is pressed, the control unit 7 deletes a facsimile/telephone number, an e-mail address, or the like, which has been once set as a recipient address, from a recipient address list. When the recipient reset key 66 is pressed, recipients that have been set so far are all cleared, and a new recipient is allowed to be set.

Again, with reference to FIG. 5, when a recipient is inputted and determined, a screen for receiving a file name is displayed on the display unit 6A under the control of the control unit 7 (Step S13).

FIG. 7 illustrates a file name input screen 50 as an example of the screen for receiving a file name. A file name input field 51, character input keys 52, an enter key 53, a clear key 54, and the like are displayed on the file name input screen 50.

A user is allowed to input a file name by pressing the character input keys 52, and the inputted file name is displayed in the file name input field 51. When the enter key 53 is pressed while a file name is being displayed in the file name input field 51, the displayed file name is determined as the name of a file.

Here, with reference to FIG. 5, when an address corresponding to the recipient address received in Step S12 is included in the addresses that were associated with the registered strings in the steps of the above section 2 (Yes in Step S14), the control unit 7 sets the registered string associated with this address to be a default file name (Step S15). Accordingly, even when a file name remains not to be inputted, the default file name is displayed in the file name input field 51. When a user's instruction is inputted through the character input keys 52 or the like, the control unit 7 is allowed to add a single or plurality of characters to the file name or delete all or a portion of the file name depending on the instruction.

For example, when any of the character input keys 52 is pressed, the control unit 7 is allowed to add a character corresponding to the pressed character input key 52 to a file name displayed in the file name input filed 51 so that the character is inserted before the initial of the file name, or after the last character of the file name, or between the initial and the last character of the file name. Also, when the clear key 54 is pressed, a character is deleted from the file name. Note that the number of characters to be deleted corresponds to the number of times that the clear key 54 is pressed.

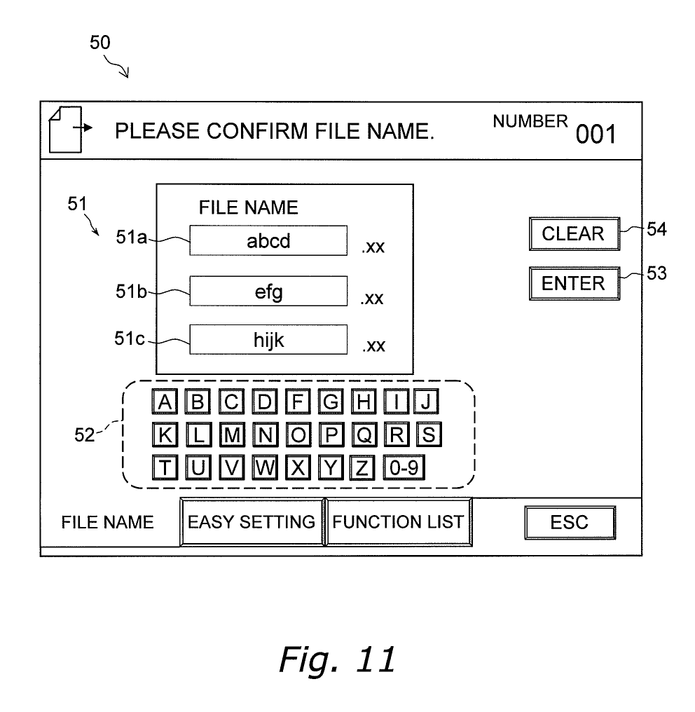

Also, when a single address is associated with a plurality of strings, the file name input screen 50 with a plurality of file name input fields 51 is displayed on the display unit 6A under the control of the control unit 7 (see FIG. 11). FIG. 11 illustrates the file name input screen 50 that includes three file name input fields 51a, 51b, and 51c. The control unit 7 is allowed to receive a user's request for selecting either of file names displayed in the file name input fields 51a, 51b, and 51c through the touch sensor.

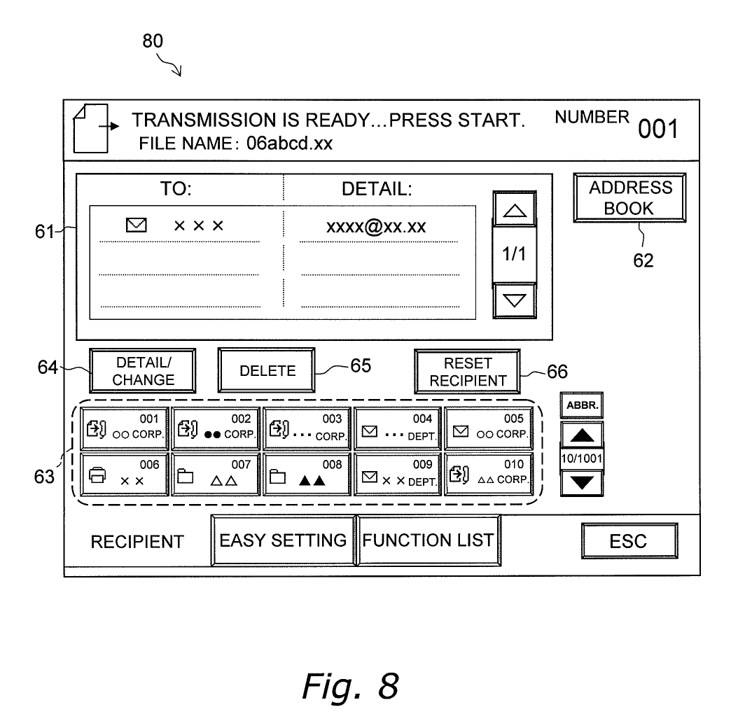

When a file name is determined, a confirmation screen is displayed on the display unit 6A under the control of the control unit 7 (Step S17), and the MFP 1 is allowed to receive an image transmission instruction. Here, a single or plurality of recipients or file names is displayed on the confirmation screen, and a user is allowed to confirm it/them. FIG. 8 illustrates a confirmation screen 80 as an example of the confirmation screen. The confirmation screen 80 is substantially the same as the recipient input screen 60 illustrated in FIG. 6 except that a single or plurality of file names and recipients is displayed on the confirmation screen 80.

When a user puts a document on a platen/document glass (not shown in the figure) and then presses a start key included in the group of physical keys 6B while the confirmation screen 80 is displayed, an image is scanned by the scanner 2 under the control of the control unit 7, and further transmitting image data obtained through the scanner 2, the storage unit 4, and the image processing unit 5 is transmitted to the externally transmitting unit 30 (Steps S18 to S20). When the image data are obtained by a method except for scanning by the scanner 2, for example, when the image data are received from an external PC through the LAN 200 or when the image data are received from an external facsimile machine, an image scanning step (Step S20) is not performed if a transmission instruction is received from a user, and a suitable processing is performed depending on circumstances.

Then, the externally transmitting unit 30 transmits the transmitting image data to a specified recipient under the control of the control unit 7 (Step S21).

When the start key is not pressed in the above Step S18, the confirmation screen 80 continues to be displayed until an instruction for canceling an operation is received, in other words, until the escape key on the screen or the cancel key included in the group of physical keys 6B is pressed. Then, when the instruction for canceling the operational steps is received (Yes in Step S22), the operational steps are terminated without performing an operation such the image scanning operation and the data transmission operation.

Note that a file assigned a file name may be stored in the storage unit 4 or the like after Step S21 or S22, and also may be deleted without being stored.

Also, as described above, a default file name may be any kind of name so long as it includes a registered string, and thus it may include other characters in addition to the registered string. Accordingly, Step S15 may be arbitrarily changed so that other characters except for the registered string may be included in the default file name.

It should be understood that configurations obtained by the heretofore known art may be used for the present invention within the scope that an object of the present invention is achieved.

### General Interpretation

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A communication device, comprising:
a transmitting unit being configured to transmit a file to an external device;
a storage unit storing a character string and an address of the external device to associate the character string and the address of the external device with each other; and
a file name setting unit setting a default name of the file to include the character string stored in the storage unit as part of the default name to associate the default name with the address to which the file is transmitted.

2. The communication device according to claim 1, further comprising a file creation unit that creates a file, and
wherein the file name setting unit sets a name of a unnamed file created by the file creation unit.

3. The communication device according to claim 1, wherein the storage unit stores a plurality of addresses and a single character string so that the plurality of addresses and the single character string are associated with each other.

4. The communication device according to claim 1, wherein the storage unit stores a single address and a plurality of character strings so that the single address and the plurality of character strings are associated with each other.

5. The communication device according to claim 1, further comprising a list presentation unit that presents a list of character strings to a user, the character strings being stored so as to be associated with addresses by the storage unit.

6. The communication device according to claim 1, further comprising
a change reception unit configured to receive a user's request to change a file name and
a file name change unit that changes the file name set by the file name setting unit based on the content of the user's request received by the change reception unit.

7. The communication device according to claim 1,
wherein the file name setting unit sets a character string including the string stored in the storage unit and at least one of the group of a number, a file transmission time, a character string indicating a client requesting a file transmission, and a character string indicating a source of the file transmission to be a default file name.

8. An image processing device, comprising:
an image scanning unit being configured to obtain image data by scanning an image on a document;
a file creation unit creating a file based on the image data;
a transmitting unit transmitting the file to an external device;
a storage unit storing a character string and an address of the external device to associate the character string and the address of the external device with each other; and
a file name setting unit setting a default file name of the file so that the default file name includes the character string stored in the storage unit so as to be associated with the address to which the file is transmitted.

9. A method for setting a file name being performed in a transmission device configured to transmit externally a file, comprising:
storing an address and a character string to associate the address and the character string with each other; and
setting a name of a file, the file name including the character string stored when storing an address and a character string so as to be associated with the address to which a file is transmitted.
